(19) United States
(12) Patent Application Publication
(10) Pub. No.: US 2008/0135562 A1
(43) Pub. Date: Jun. 12, 2008

(54) Fuel Tank Assembly and Fuel Tank

(75) Inventor: Atsuo Miyajima, Aichi-ken (JP)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Tokai Rubber Industries, Ltd., Aichi-ken (JP)

(21) Appl. No.: 11/951,537

(22) Filed: Dec. 6, 2007

(30) Foreign Application Priority Data
Dec. 8, 2006 (JP) 2006-332680

(51) Int. Cl. B60P 3/00

(52) U.S. Cl. 220/562

(57) ABSTRACT

A resin fuel tank has an annular welded portion around an opening formed in the fuel tank. A resin weld joint has an annular weld portion. The weld joint is mounted to the fuel tank by bonding the weld portion of the weld joint to the annular welded portion of the fuel tank through application of heat-welding under pressure. The fuel tank is provided with reinforcing ribs arranged radially around the annular welded portion.

### BACKGROUND OF THE INVENTION

1. Field of the Invention

The present invention relates to a fuel tank assembly comprising a fuel tank and a resin weld joint welded and mounted to the fuel tank for connection to a piping tube or a piping connector, and relates to the fuel tank adapted in the fuel tank assembly.

2. Description of the Related Art

A fuel tank equipped in a motor vehicle integrally has a joint that provides connection between the fuel tank and a tube, a connector or the like for introducing a fuel that is fed via a filler opening to the fuel tank.

Here, for example, for the tube introducing a fuel from the filler opening to the fuel tank, a tube made of rubber (rubber hose) has been used conventionally. In recent years, however, environmental regulations have been increasingly requiring to restrict a fuel from permeating out through a hose in view of environmental protection. This results in that, for a piping tube, employed is a rubber-resin composite hose of a composite of a rubber hose and a gas-barrier resin layer of fuel impermeability, a rubber tube formed of a fluoro-rubber of fuel impermeability or a resin tube made solely of resin.

For example, a connecting structure as shown in FIG. 4 has been conventionally employed for connecting between such a tube and a fuel tank.

In FIG. 4, reference numeral 200 indicates a fuel tank made of resin, and reference numeral 202 indicates a weld joint also made of resin. The weld joint 202 is bonded integrally to the fuel tank 200 through application of heat-welding, or thermal-welding.

The weld joint 202 has a tubular portion 204 adapted for being inserted relatively into a tube, and an annular flange portion 206 projecting from an outer peripheral surface of the tubular portion 204.

Reference numeral 208 indicates a resin tube for introducing a fuel that is fed via a filler opening to the fuel tank 200. As shown in FIG. 4B, the resin tube 208 has a corrugated portion 210 that provides the resin tube 208 with flexibility.

In FIGS. 4B and 5, reference numeral 212 indicates a connector (quick connector). The resin tube 208 is connected to the weld joint 202 via the connector 212.

The connector 212 has a connector body 214 made of resin and a retainer 216 also made of resin.

The connector body 214 has a nipple portion 218 on one axial end thereof, and a socket like retainer holding portion 230 on the other axial end thereof. The retainer 216 is inserted resiliently in and held in the retainer holding portion 230.

The nipple portion 218 is press-fitted or force-fitted relatively in the resin tube 208 and secures the resin tube 208 thereon. The nipple portion 218 has a stop portion that is provided with a plurality of annular projecting portions 232 axially spaced on its outer peripheral surface. The stop portion has a saw-toothed cross-section. In an inner periphery of the nipple portion 218, a plurality of O-rings (seal rings) 234 are retained.

On the other hand, the socket like retainer holding portion 230 is formed with a circular arc window portion 236, and a partial-ring-shaped portion 238 of a corresponding circular arc shape.

The retainer 216 is entirely resiliently deformable in a radial direction. The retainer 216 has a circular arc groove 240 for resiliently fitting to the partial-ring-shaped portion 238 of the retainer holding portion 230, a tapered guide surface 242 for assisting axial insertion of the flange portion 206 of the weld joint 202 and assisting resilient diametrical expansion of the entire retainer 216, and circular arc fit-in slits 244 for fit-engaging the flange portion 206 therein.

In this connecting structure, an end portion of the resin tube 208 is forcibly press-fitted on the nipple portion 218 of the connector body 214, and is secured thereto.

During that state, the end portion of the resin tube 208 is deformed and diametrically expanded or flared by being press-fitted on the nipple portion 218 as shown in FIG. 4B, and radially tightens against the nipple portion 218 with a large tightening force.

This tightening force and a wedging function of the annular projecting portions 232 of the nipple portion 218 retain the end portion of the resin tube 208 onto the connector body 214 in a secured state.

Then, while the retainer 216 is mounted and held in the connector body 214, the connector 212 is fitted on the tubular portion 204 of the weld joint 202.

During that time, the retainer 216 held in the connector body 214 is resiliently deformed and diametrically expanded or flared by the flange portion 206. As soon as the flange portion 206 reaches the fit-in slits 244, the retainer 216 is resiliently deformed and diametrically contracted again to engage the flange portion 206 in the fit-in slits 244.

At the same time, a leading end of the tubular portion 204 with respect to the flange portion 206 fits in the O-rings 234 in an inner periphery of the connector body 214, and thereby an air tight seal is provided between the tubular portion 204 and the connector body 214.

On the other hand, aside from this, there is an idea that the resin tube 208 is connected to the weld joint 202 by putting or fitting the resin tube 208 immediately (directly) on the tubular portion 204 of the weld joint 202, without use of the above-mentioned connector 212.

Meanwhile, such weld joint adapted for connecting to a connector (quick connector) or connecting directly to a fuel piping tube is integrally bonded to a fuel tank by heat-welding as stated above. However, the following problem arises when a connecting portion for the tube is formed by bonding the weld joint integrally to the fuel tank through application of heat-welding.

Conventionally, for a material of an outer layer of the fuel tank, high density polyethylene (HDPE) resin has been used. So, the weld joint to be bonded integrally to the fuel tank is required to be weldable to the material of the outer layer.

Accordingly, there is an idea that the entire weld joint including a tubular portion is made of the same material of HDPE resin. HDPE resin is excellent in weldability to the fuel tank, but insufficient in fuel permeation resistance (fuel impermeability). This causes a problem that a fuel permeates out through this portion.

Patent Document 1 stated below discloses a weld joint for the purpose of solving the problem relative to fuel impermeability. According to Patent Document 1, the weld joint is constructed by radially laying an outer layer having weldability to a fuel tank on an inner layer made of resin having fuel impermeability (gas-barrier property).

FIG. 6 shows an illustrative example of such weld joint.

In FIG. 6, reference numeral 246 indicates a resin fuel tank constructed by laying an outer layer 246-1 made of HDPE resin, a gas-barrier layer 246-2 made of ethylene-vinyl alcohol copolymer (EVOH) resin of superior fuel impermeability and an inner layer 246-3 made of HDPE resin, on one another.

Reference numeral 248 indicates a resin weld joint that is welded integrally to the fuel tank 246. The weld joint 248 has a tubular portion 252 serving as a connecting portion (a plug-in portion) to a tube 258, and a weld portion 250 at a base end portion thereof. The weld joint 248 is bonded to the fuel tank 246 at the weld portion 250 by heat-welding.

The tubular portion 252 has an outer layer 254 and an inner layer 256. The outer layer 254 and the inner layer 256 are made of different resin materials. Specifically, the outer layer 254 is made of the same material as the weld portion 250, and the inner layer 256 is made of gas-barrier material such as polyamide (PA) resin that is more excellent in fuel impermeability than the outer layer 254.

Meantime, reference numeral 260 indicates a hose band for securing the tube 258 on the tubular portion 252 in a fit-on state by clamping the tube 258.

In the weld joint 248 of this construction, the outer layer 254 of the tubular portion 252 and the weld portion 250 are made of HDPE resin of the same material as the outer-layer 246-1 of the fuel tank 246. As stated above, HDPE resin has good weldability to the fuel tank 246. But, HDPE resin does not have sufficient fuel impermeability, in the weld joint 248 as shown in FIG. 6, the inner layer 256 made of the gas-barrier material is provided in the tubular portion 252. Therefore, fuel impermeability is ensured for the tubular portion 252. However, the weld portion 250 of HDPE resin is left, so to speak, in exposed condition.

So, a weld joint 262 as shown in FIG. 7 is proposed in the previous patent application (Patent Document 2 as stated below). The entire weld joint 262, specifically the entire weld joint 262 including a tubular portion 264 and a weld portion 266 to be welded to a fuel tank 246 is made of a resin alloy material obtained by alloying EVOH with a modified HDPE (not with HDPE), or a resin alloy material obtained by alloying EVOH with the modified HDPE and HDPE. The modified HDPE is obtained by introducing a functional group of high affinity for a hydroxyl group of EVOH into HDPE.

EVOH has been known as a material having excellent gas-barrier property or fuel-barrier property since a long time ago. The resin alloy material obtained by alloying such EVOH with the above-mentioned modified HDPE (not with HDPE) or the resin alloy material obtained by alloying such EVOH with the above-mentioned modified HDPE and HDPE has excellent weldability to the fuel tank 246 derived from HDPE contained herein, and also has very excellent fuel impermeability (gas-barrier property) derived from EVOH. Therefore, in the construction as shown in FIG. 7, the tubular portion 264 and the weld portion 266 can be provided with good fuel impermeability, and at the same time, the weld portion 266 can be expected to have high weldability to the fuel tank 246. Further, in the weld joint 262, because the entire weld joint 262 including the tubular portion 264 and the weld portion 266 is made of the same single material, the number of the steps required for production or formation can be reduced and thereby the cost for the weld joint 262 can be reduced.

However, as a result of a test for weld performance of the weld joint 262 to the fuel tank 246, it is found that weld strength of the weld joint 262 to the fuel tank 246 actually varies, resulting sufficient weld strength cannot be obtained consistently.

In the weld joint 262 made of the above resin alloy material shown in FIG. 7, the weld portion 266 has higher weldability compared to a weld joint solely made of EVOH, but does not have so high weldability as a weld portion made of HDPE resin has. Due to this reason, when the weld joint 262 is welded to the resin fuel tank 246 at the weld portion 266, the weld portion 266 is not welded sometimes sufficiently. That is, there exist variations in welding result or welding strength.

The inventor of the present invention then investigated the cause of these variations of the welding strength, and found out the major cause as follows. That means, the fuel tank 246 has low rigidity at an annular welded portion 276 around the opening 274 and a portion of the fuel tank 246 around the annular welded portion 276. So, when the weld portion 266 of the weld joint 262 is welded to the welded portion 276 by applying pressure, the welded portion 276 is deformed to dent into the fuel tank 246 due to the applied pressure.

Typically, a weld joint is welded to the fuel tank 246 as shown in FIG. 8.

In the Figure, reference numeral 268 indicates a resin weld joint that has a different configuration from that shown in FIG. 7. Reference numeral 270 indicates a tubular portion and reference numeral 272 indicates a weld portion.

Reference numeral 274 indicates an opening of the fuel tank 246, and reference numeral 276 indicates an annular welded portion around the opening 274 or on an outer circumference of the opening 274.

The weld joint 268 is welded to the fuel tank 246 in the following manner as shown in the Figure. First, as shown in FIG. 8A, a hot plate 278 is inserted between the weld portion 272 of the weld joint 268 and the fuel tank 246, and the hot plate 278 is sandwiched by the weld portion 272 of the weld joint 268 and the welded portion 276 of the fuel tank 246 (refer to FIG. 8B). After the weld portion 272 and the welded portion 276 are thereby molten, the hot plate 278 is removed from therebetween as shown in FIG. 8C. Then, as in FIG. 8D, the weld portion 272 is pressed or compressed onto the welded portion 276 of the fuel tank 246 to fuse molten parts of the weld portion 272 and the welded portion 276, respectively, thereby the weld joint 268 is welded and mounted integrally to the fuel tank 246.

However, when the weld joint 268 is pressed against the fuel tank 246, the fuel tank 246, specifically, the welded portion 276 around the opening 274 and a vicinity thereof may be deformed in a direction as indicated by an arrow in the FIG. 8D, namely deformed so as to dent into the fuel tank 246, under applied pressure. Due to this reason, bonding pressure or pressure bonding force required for welding may be insufficient as a whole, or the welded portion 276 and the vicinity may be deformed non-uniformly in a circumferential direction and bonding pressure may come short at a region deformed largely, resulting that welding strength of the weld joint 268 to the fuel tank 246 varies.

The above explanation is given, taking the weld joint entirely made of the resin alloy material of EVOH and modified HDPE as a typical example. However, the above problem is found equally even in such case that the weld portion is made of various other materials.

Meantime, Patent Document 3 stated below discloses a conventional art related to the present invention where a fuel tank has an annular inwardly projecting portion while a pipe has a flange, the pipe is press-fitted in the annular inwardly projecting portion, thereby fuel permeation is prevented.

However, the invention of Patent Document 3 is different from the present invention in terms of an object and means for solving a problem.

| | |
|---|---|
| [Patent Document 1] | JP-A-2002-254938 |
| [Patent Document 2] | JP-A-2006-143172 |
| [Patent Document 3] | JP-A-2002-339825 |

Under the circumstances described above, it is an object of the present invention to provide a fuel tank assembly where a resin weld joint is welded and mounted to a fuel tank also made of resin with consistent and sufficient welding strength. It is another object of the present invention to provide a fuel tank to which a resin weld joint is welded and mounted with consistent and sufficient welding strength.

### SUMMARY OF THE INVENTION

According to the present invention, there is provided a novel fuel tank assembly. The fuel tank assembly comprises a resin fuel tank having an annular welded portion around an opening formed in the fuel tank, and a resin weld joint including a tubular portion for connecting to a tube or a connector in piping, and an annular weld portion at a base end portion of the weld joint. The resin fuel tank may comprise a resin tank body, an opening formed in the tank body, and an annular welded portion of the tank body around the opening. The resin fuel tank may be formed by blow-molding. The weld joint is mounted to the fuel tank by bonding the weld portion to the annular welded portion through application of heat-welding under pressure. The fuel tank is provided with reinforcing ribs arranged radially, arranged in a radial layout, or arranged in a radial pattern around the annular welded portion.

According to one aspect of the present invention, the fuel tank (tank body) has a depressed portion that is depressed inwardly into the fuel tank (tank body) around the annular welded portion throughout or along an entire circumference of the annular welded portion. The annular welded portion has a cylindrical shape rising and projecting from the depressed portion toward outside the fuel tank (tank body), and the reinforcing ribs extend radially across the depressed portion. For example, the annular welded portion has a welded surface that is at the same height as an outer surface of a portion of the fuel tank (tank body) around the depressed portion or on an outer circumference of the depressed portion.

According to the present invention, there is also provided a novel resin fuel tank. The resin fuel tank is mounted with a resin weld joint. The fuel tank comprises a resin tank body, an opening formed in the tank body, and an annular welded portion of the tank body around the opening. The annular welded portion of the tank body is adapted for bonding an annular weld portion of the weld joint thereto by heat-welding under pressure. The fuel tank is provided with reinforcing ribs arranged radially in the tank body around the annular welded portion.

According to one aspect of the present invention, the fuel tank further comprises a depressed portion in the tank body around the annular welded portion. The depressed portion is depressed inwardly into the fuel tank body throughout or along an entire circumference of the annular welded portion. The annular welded portion has a cylindrical shape rising and projecting from the depressed portion toward outside the tank body, and the reinforcing ribs extend radially across the depressed portion. For example, the annular welded portion has a welded surface that is at the same height as an outer surface of a portion of the tank body around the depressed portion or on an outer circumference of the depressed portion.

According to the present invention, there is provided another novel fuel tank assembly. The fuel tank assembly comprises a resin fuel tank having an annular weld mounting portion around an opening formed in the fuel tank, and a resin weld joint including a connecting portion for piping, and an annular weld portion. The resin fuel tank may comprise a resin tank body, an opening formed in the tank body, and an annular weld mounting portion of the tank body around the opening. The weld joint is mounted to the fuel tank (tank body) by pressing and welding the weld portion to the weld mounting portion through application of heat-welding. The fuel tank (tank body) has a plurality of depressed portions depressed inwardly into the fuel tank (tank body) around the weld mounting portion. The depressed portions are arranged discontinuously in a circumferential direction along the weld mounting portion so as to form a partition wall between each adjacent pair of the depressed portions. The partition walls extend radially and each of the partition walls serves as a reinforcing rib.

As stated above, according to the present invention, the reinforcing ribs are provided radially around the annular welded portion on the fuel tank. In this case, the reinforcing ribs provided radially around the welded portion enhance rigidity of a portion of the fuel tank around the welded portion. As a result, a pressure applied by the weld portion of the weld joint onto the welded portion of the fuel tank can be borne firmly by the welded portion of the fuel tank when the weld portion is bonded to the welded portion of the fuel tank by heat-welding under pressure.

That is, it is favorably prevented that the welded portion and its vicinity are deformed to dent into the fuel tank due to the pressure applied in the welding procedure, thereby there may be provided a sufficient pressure bonding strength between the weld portion of the weld joint and the welded portion of the fuel tank.

This can provide a stable and sufficient welding strength between the weld joint and the fuel tank.

And, the fuel tank may be provided with a depressed portion that is depressed inwardly into the fuel tank around the welded portion throughout an entire circumference of the welded portion and the welded portion may have a cylindrical shape defined by the depressed portion so as to rise and protrude toward outside the fuel tank. And, the reinforcing ribs may be provided radially so as to cross over the depressed portion.

This arrangement effectively enhances rigidity of a portion of the fuel tank around the welded portion, while the welded portion is formed not to project upward largely from an outer surface of the fuel tank.

In the case that a fuel tank is provided under a vehicle floor, a space between the vehicle floor and an upper surface of the fuel tank is required to be as small as possible in order to secure a certain distance between the fuel tank and a road. However, when a welded portion protrudes upward largely from an outer surface (a top surface) of the fuel tank, a large distance should be necessarily left between the fuel tank (a tank body) and the vehicle floor, and accordingly, the fuel tank has to be installed at a lower position by that distance.

Such is not desired. In the case that the welded portion and its vicinity is designed as described above, it can be prevented that the welded portion has a shape largely protruding from the outer surface of the fuel tank (the tank body), thereby the fuel tank can be installed at a position as close as possible to the vehicle floor.

In particular, the welded portion is preferably provided such that a welded surface of the welded portion to which the weld joint is welded is at the same height as an outer surface of the fuel tank around the depressed portion or on an outer circumference of the depressed portion.

Also, according to one aspect of the present invention, there is provided a fuel tank assembly or a fuel tank where a plurality of depressed portions depressed inwardly into the fuel tank are provided around a weld mounting portion of the fuel tank. The depressed portions are arranged so as to form a partition wall serving as a reinforcing rib between each adjacent pair of the depressed portions. This arrangement also may enhance rigidity of a portion of the fuel tank around the weld mounting portion, while the weld mounting portion is formed not to project largely out of an outer surface of the fuel tank.

Now, the preferred embodiments of the present invention will be described in detail with reference to the drawings.

### BRIEF DESCRIPTION OF THE DRAWINGS

FIG. 1 is a view showing a fuel tank assembly with a weld joint bonded to a fuel tank through application of welding, according to an embodiment of the present invention.

FIG. 2A is a view of a relevant part of the fuel tank of FIG. 1.

FIG. 2B is a sectional view taken along the line B-B of FIG. 2A.

FIG. 3A is a perspective view of the weld joint of FIG. 1.

FIG. 3B is another perspective view of the weld joint of FIG. 1.

FIG. 4A is a view for explaining a conventional structure for connecting a resin tube to a fuel tank.

FIG. 4B is a sectional view of the structure of FIG. 4A.

FIG. 5 is an exploded sectional view showing each component in the structure of FIG. 4A.

FIG. 6 is a view showing an example of construction of a conventionally known weld joint.

FIG. 7 is a view showing a construction of a conventionally known weld joint, different from that of FIG. 6.

FIGS. 8A to 8D are view showing a process for mounting of a weld joint to a fuel tank by heat-welding.

### DETAILED DESCRIPTION OF THE PREFERRED EMBODIMENTS

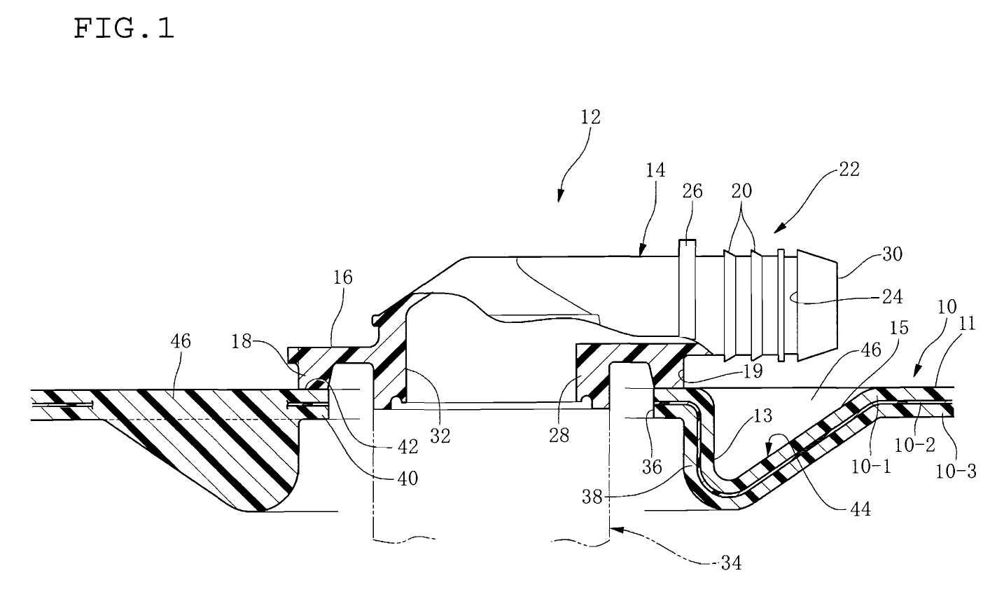

In FIG. 1, reference numeral 10 indicates a resin fuel tank, and reference numeral 11 indicates a resin tank body of the fuel tank 10. The resin fuel tank 10 or the resin tank body 11 has a multilayer construction that includes outer and inner layers 10-1, 10-3 made of HDPE or HDPE resin and a gas-barrier layer 10-2 sandwiched between the outer layer 10-1 and the inner layer 10-3. The gas-barrier layer 10-2 is made of EVOH or EVOH resin and has excellent fuel impermeability.

Reference numeral 12 indicates a weld joint made of resin. The weld joint 12 has a tubular portion 14 serving a connecting portion to a piping tube (hereinafter referred to simply as a tube), a disk-shaped flange portion 16 at a base end portion of the tubular portion 14 or the weld joint 12 and an annular or circular ring shaped weld portion 18. The weld portion 18 extends downwardly (toward the fuel tank 10), from the disk-shaped flange portion, specifically from an outer circumferential end portion of the flange portion 16.

The weld joint 12 is integrally assembled or mounted to the fuel tank 10 or the tank body 11 by bonding the weld portion 18 to the fuel tank 10 or the tube body 11 through application of heat-welding.

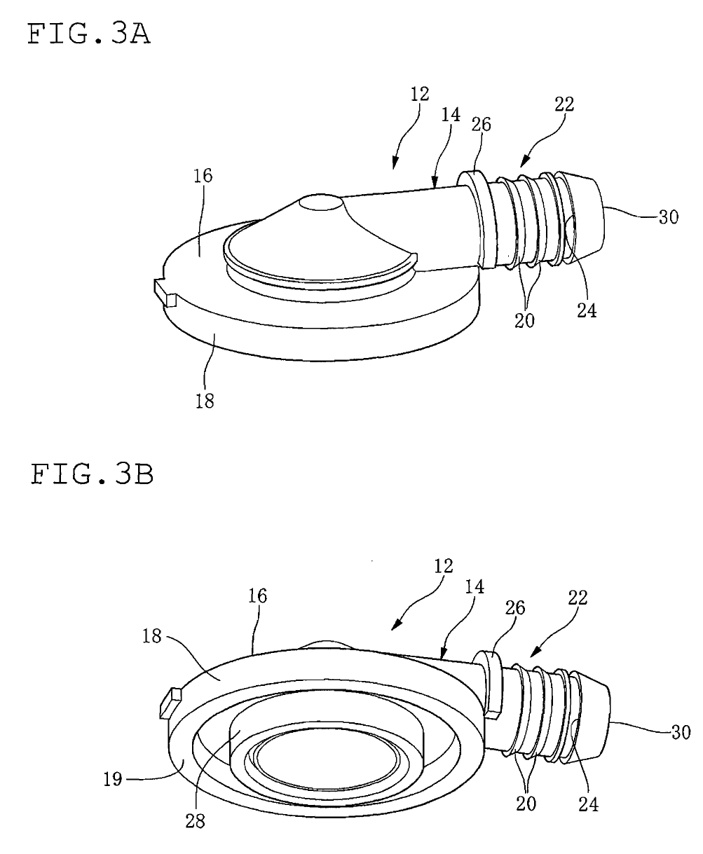

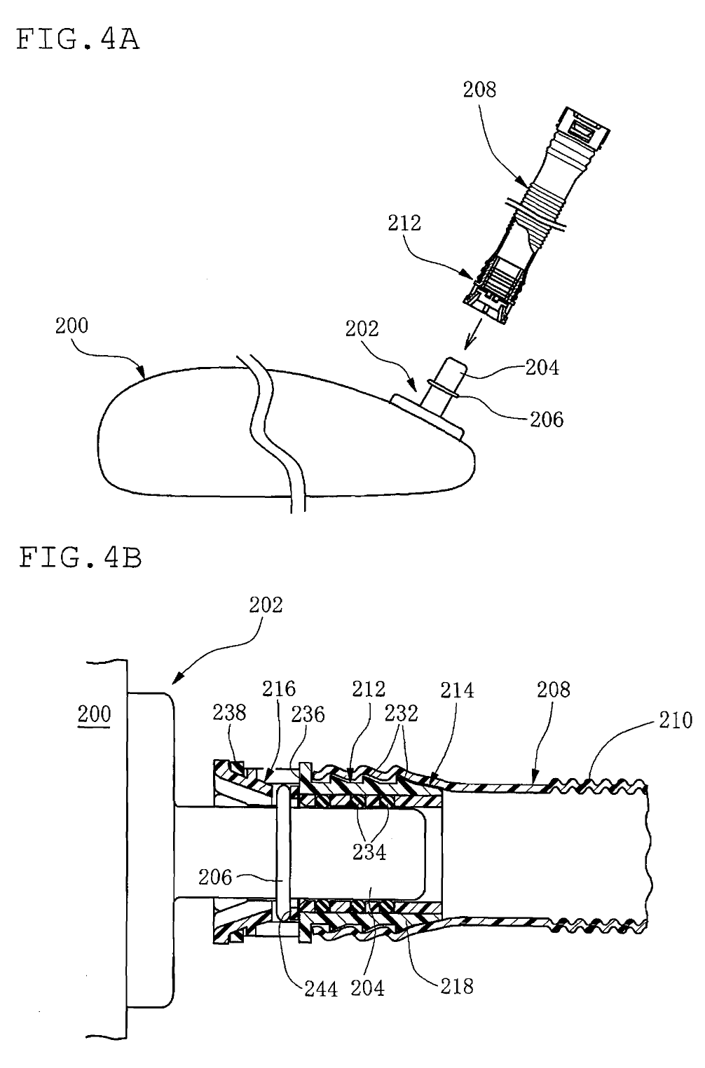

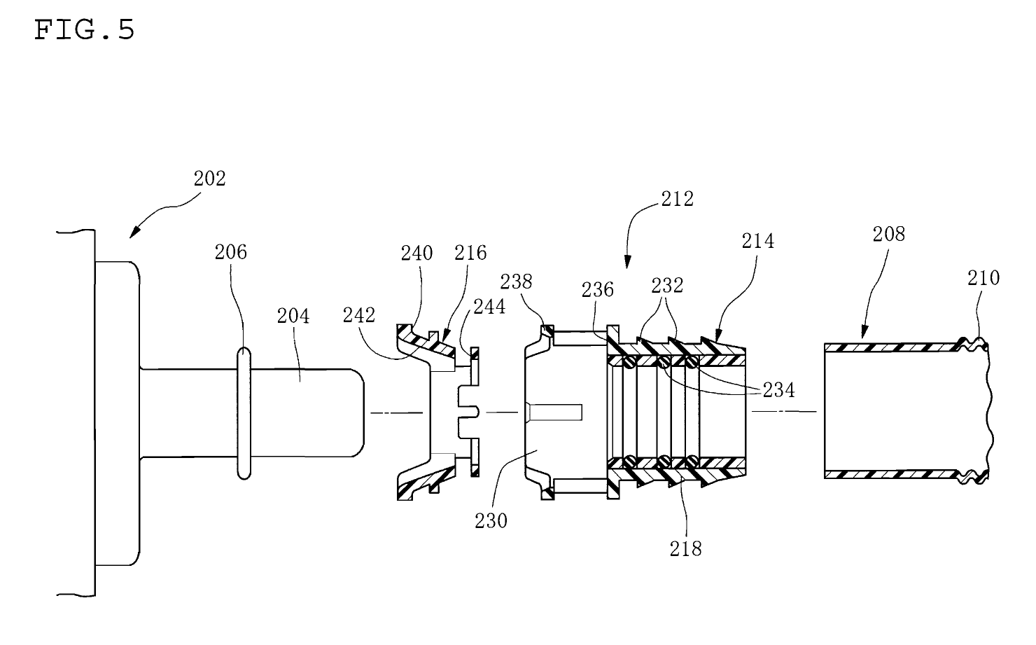

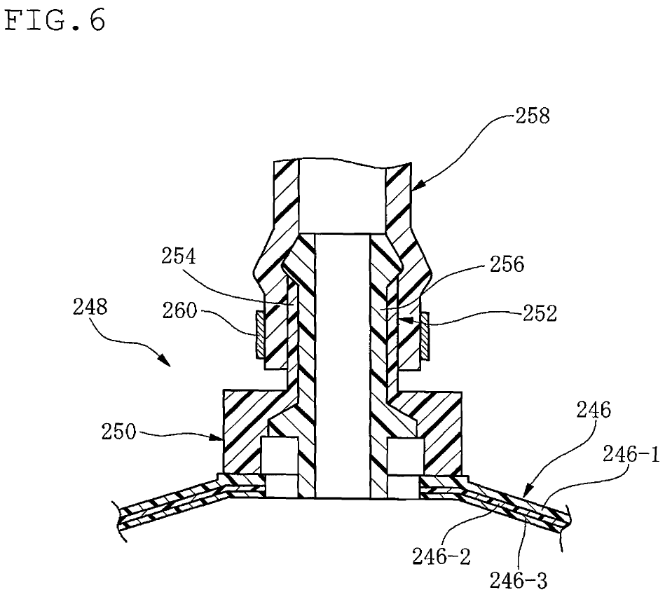

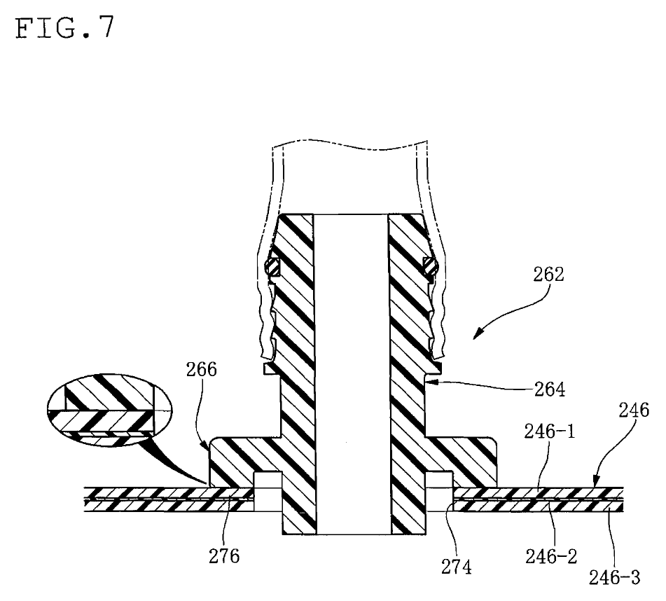

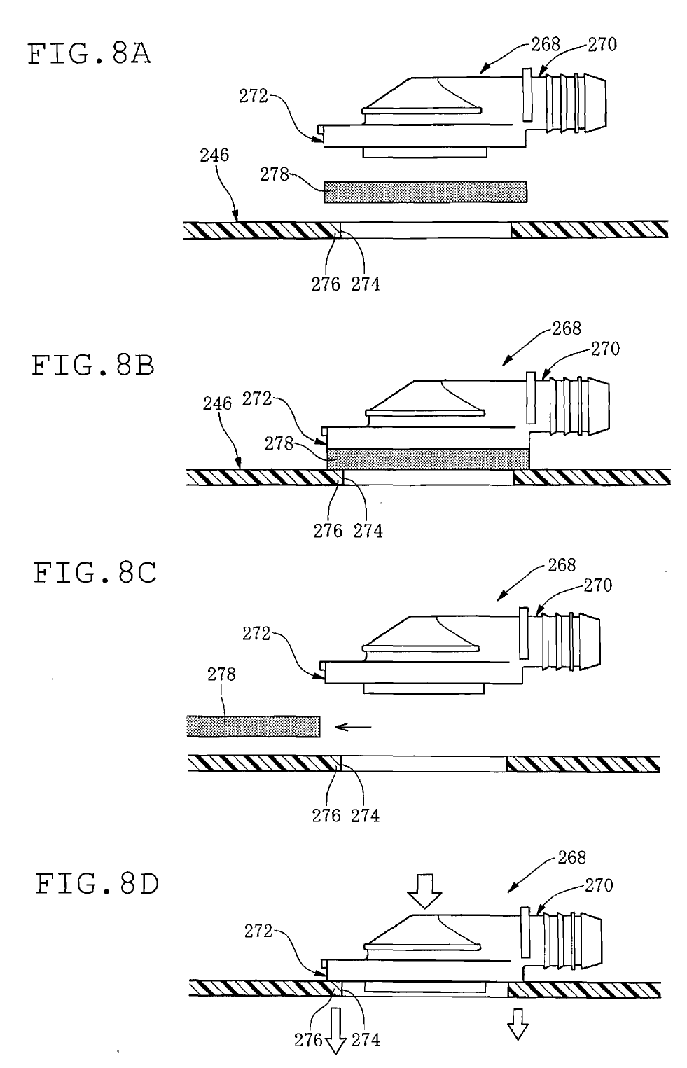

Specifically, as shown also in FIG. 3, a lower end surface or an extremity end surface (an end surface facing the fuel tank 10) of the downwardly extended weld portion 18 serves as a weld surface 19. Thus configured weld portion 18 is assembled or bonded integrally to a welded portion 38 (to be described later) of the fuel tank 10 at the weld surface 19 by heat-welding.

Here, the tubular portion 14 serves as a portion being relatively press-fitted into the tube to secure the tube thereon. The tube is connected to the fuel tank 10 via thus configured weld joint 12.

The tubular portion 14 has a stop portion 22 on its outer peripheral surface, and the stop portion 22 is provided with a plurality of annular projecting portions 20 axially spaced and has a saw-toothed cross-section.

The stop portion 22 serves to provide a stop for preventing withdrawal of the tube by wedging each of the annular projecting portions 20 with acute angled peaks in an inner surface of the tube.

The tubular portion 14 also has an annular O-ring groove 24 in a leading end thereof. An elastic O-ring serving as a sealing member is to be fitted in the O-ring groove 24.

The tubular portion 14 further has a stopper portion 26 of a generally annular shape on the left with respect to the stop portion 22 in the Figure (FIGS. 1 and 3).

The stopper portion 26 serves to limit an inserted length of the tubular portion 14 with respect to the tube by contacting with a leading end of the tube when the tube is fitted on the tubular portion 14.

The weld joint 12 is further provided integrally with a circular ring shaped protruding portion 28 protruding toward the fuel tank 10 inside the circular ring shaped weld portion 18. The protruding portion 28 internally has an opening 32 that communicates with an opening 30 of the leading end of the tubular portion 14.

Here, the protruding portion 28 is adapted for connection to a resin housing 34 of a valve or the like that is arranged in the fuel tank 10.

In this embodiment, the weld joint 12 is entirely made of the following material, namely, a resin alloy material obtained by alloying EVOH solely with modified HDPE (namely, with modified HDPE, but not with HDPE), or a resin alloy material obtained by alloying EVOH with the modified HDPE and HDPE (a typical or normal HDPE). The modified HDPE is obtained by introducing a functional group having a high affinity for a hydroxyl group of EVOH into HDPE.

The reason why the modified HDPE is used instead of typical HDPE for the material to be alloyed with EVOH in this embodiment is as follows.

Typical HDPE has low affinity for EVOH. Therefore, when typical HDPE and EVOH are just alloyed, large agglomerations of EVOH (for example, EVOH and HDPE) are produced due to their non-affinity. Therefore, EVOH (for example, EVOH and HDPE) does not present evenly or uniformly.

In this case, although EVOH by itself is excellent in fuel impermeability, EVOH takes forms of large agglomerations, these large agglomerations are separated each other in a matrix of HDPE (when the matrix is formed by HDPE). Consequently, a fuel gas easily passes out through these agglomerations of EVOH.

EVOH and HDPE are non compatible with each other. So, even when EVOH and HDPE are physically mixed or blended, EVOH and HDPE are separated from each other, thereby a phase boundary of low affinity is formed.

As a result, this mixed material (or blended material) is brought into a state where the mixed material includes the large agglomerations of EVOH almost like foreign materials. Consequently, strength of the mixed material may become low (namely, the mixed material may be in a brittle condition). Also, phase separation may be readily caused at or along the phase boundary therebetween.

On the contrary, in this embodiment, for a material to be alloyed with EVOH, used is the modified HDPE resin that is obtained by introducing a functional group having chemical reactivity (mainly in terms of a hydrogen bond and a covalent bond) to a hydroxyl group of EVOH into HDPE. Therefore, EVOH and HDPE (or the modified HDPE) are mixed and dispersed evenly or uniformly, and both of the materials are well blended each other.

Thereby both of good weldability (namely, weldability to the fuel tank 10 or the tank body 11) and fuel impermeability (gas-barrier property) are realized.

The reason why EVOH and HDPE or the modified HDPE are mixed and dispersed evenly or uniformly, and are fused to each other into a homogeneous phase is that HDPE is provided with high affinity for EVOH as a result of being modified by introducing the functional group thereinto.

And, the resin alloy material of EVOH and the modified HDPE has an enhanced impact resistance as well as an enhanced strength, since EVOH and HDPE or the modified HDPE are mixed and dispersed evenly or uniformly to form the homogeneous phase.

Here, a modifying group, namely, the functional group to be introduced into HDPE may be, for example, a carboxylic acid group, a carboxylic acid anhydride, an epoxy group, an acrylate group, a methacrylate group, a vinyl acetate group, an amino group, or the like.

Welding strength may be enhanced by increasing a ratio of HDPE (or the modified HDPE) in the resin alloy material, while fuel impermeability may be enhanced by increasing a ratio of EVOH in the resin alloy material. As such, a requirement for either of improved welding strength or improved fuel impermeability can be met by adjusting the ratio of HDPE (or the modified HDPE) or EVOH in the resin alloy material. The volume ratio of EVOH/the modified HDPE (EVOH to modified HDPE) may be set in a range from 80/20 to 15/85.

The above blend does not require to contain a compatibilizer or compatibilizing material. This is also a factor in enhancing the fuel impermeability. Incidentally, according to need, the compatibilizer, inorganic filler or the like may be blended in the resin alloy material. However, an excessive compatibilizer could deteriorate crystalline properties of a base material, resulting in increased fuel permeability (namely, gas-barrier property is lowered). Thus, an amount of the compatibilizer to be added should be decided to an extent capable of ensuring a required gas-barrier property.

Moreover, besides the resin alloy material obtained by alloying EVOH solely with the modified HDPE (namely not with HDPE), the resin alloy material may be obtained by alloying EVOH with both of typical HDPE and the modified HDPE.

In this embodiment, the above resin alloy material may have a sea-island structure including one of EVOH and the modified HDPE as a sea component and the other of them as an island component.

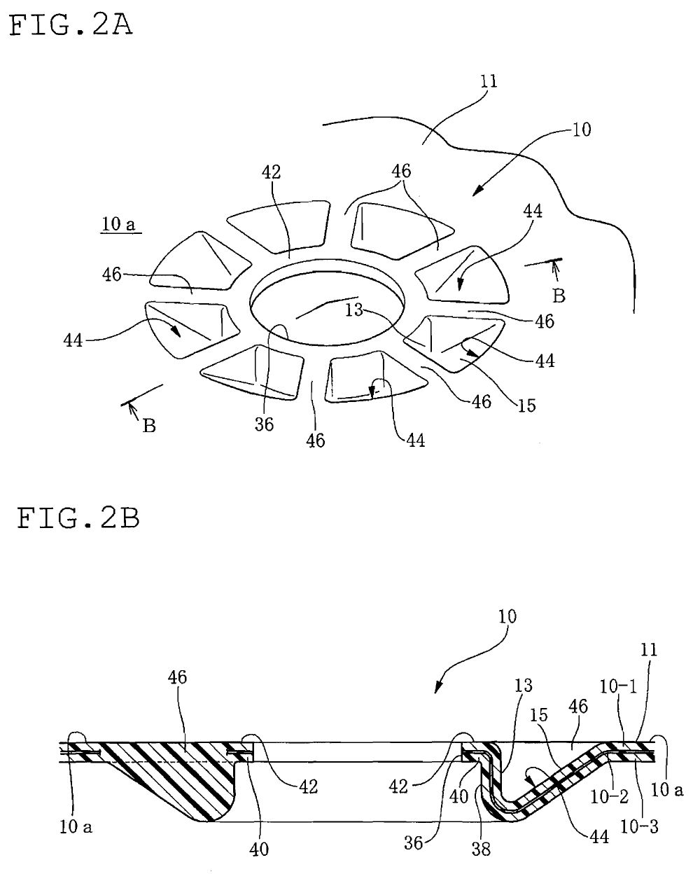

FIG. 2 shows a shape of a relevant part of the fuel tank 10 before the weld joint 12 is welded thereto.

In the Figure, reference numeral 36 indicates an opening of the fuel tank 10 or the tank body 11, and reference numeral 38 indicates a welded portion formed around the opening 36. The welded portion 38 has a cylindrical shape rising and projecting toward outside the fuel tank 10 or the tank body 11. An upper end portion of the welded portion 38 is bent toward the opening 36 generally at a right angle to define a bent portion 40. The bent portion 40 serves as an annular weld mounting portion

A top surface of the bent portion (the annular weld mounting portion) 40 in the Figure (FIG. 2) is defined as a welded surface 42. The weld portion 18 of the above mentioned weld joint 12, specifically the weld surface 19 defined by the lower end surface of the weld portion 18 is bonded to the welded surface 42 by heat-welding, thereby the weld joint 12 is mounted integrally to the fuel tank 10 or the tank body 11.

Meantime, the bent portion 40, specifically its top surface, namely the welded surface 42 takes a form of a circular ring around the opening 36, corresponding the weld surface 19 of the weld portion 18 of the weld joint 12 (refer to FIG. 2A).

In the fuel tank 10, a portion around the welded portion 38 or the weld mounting portion 40 is depressed inwardly into the fuel tank 10 throughout an entire circumference of the welded portion 38 or the weld mounting portion 40 to define a depressed portion 44.

The depressed portion 44 has a cross-section of a generally triangle so as to increase its depressed length or depth from an outer circumferential end toward an inner circumferential end thereof. And, the above mentioned welded portion 38 rises or extends upwardly from the deepest position of the inner circumferential end of the depressed portion 44 (refer to FIG. 2B).

In this embodiment, the welded portion 38 of an uprising shape is formed such that its top end surface, namely the welded surface 42 is at the same height as an outer surface (a tank outer surface) 10a of a region of the fuel tank 10 extending radially outward of the depressed portion 44.

And, in this embodiment, reinforcing ribs 46 are arranged around the welded portion 38, at certain or equal intervals circumferentially so as to bridge or cross over the depressed portion 44 in a radial pattern.

Here, each of the reinforcing ribs 46 extends at the same height as the welded surface 42 and an outer end surface of the reinforcing rib 46 connects to an outer circumferential end of the depressed portion 44.

Each of the reinforcing ribs 46 takes a form of a board, and is arranged in a vertical direction with its front and rear surfaces extending in a top to bottom direction.

The reinforcing structure as stated above also can be understood as follows. A plurality of depressed portions 44 depressed inwardly into the fuel tank 10 are formed around the weld mounting portion 40, the depressed portions 44 are arranged discontinuously in a circumferential direction along the weld mounting portion 10, and each of the reinforcing ribs 46 is defined by a partition wall 46 between each adjacent pair of the depressed portions 44. The depressed portion 44 has a front wall 13 and a bottom portion 15.

According to this embodiment, the weld joint 12 shown in FIG. 3, which is formed separately from the fuel tank 10 of FIG. 2, is bonded or welded to the fuel tank 10 or the tank body 11 in the following manner.

First, the weld joint 12 is disposed and held above the opening 36 of the fuel tank 10. Then, a hot plate is sandwiched by the weld portion 18 of the weld joint 12 and the welded portion 38 of the fuel tank 10 to melt the weld surfaced 19 of the weld portion 18 and the welded surface 42 of the welded portion 38, respectively, through application of heat of the hot plate.

After that, the hot plate is removed, and the weld portion 18 of the weld joint 12 is laid on the welded portion or the bent portion 40 of the fuel tank 10 to be pressed against the welded portion 40 at a predetermined pressure in a downward direction in the Figure.

Through these procedures, the welded surface 19 of the weld joint 12 and the welded surface 42 of the fuel tank 10 are fused to each other, and the weld joint 12 is bonded and mounted integrally to the fuel tank 10 by heat-welding.

In the embodiment as above, the reinforcing ribs 46 provided radially around the welded portion 38 enhance rigidity of the welded portion 38 of the fuel tank 10 and a portion around the welded portion 38. As a result, while the weld portion 18 of the weld joint 12 is pressed against the welded portion 38 of the fuel tank 10 through application of pressure in the welding procedure, the pressure is borne by the welded portion 38 firmly.

That is, it is favorably prevented that the welded portion 38 and a vicinity thereof are deformed to dent into the fuel tank 10 due to the pressure applied in the welding procedure, thereby there may be provided a sufficient pressure bonding strength between the weld portion 18 of the weld joint 12 and the welded portion 38 of the fuel tank 10.

This can provide a consistent and sufficient welding strength between the weld joint 12 and the fuel tank 10.

And, the fuel tank 10 or the tank body 11 of this embodiment is provided with the depressed portion 44 around the welded portion 38 and further provided with the reinforcing ribs 46 that extend across the depressed portion 44 radially. This configuration effectively enhances rigidity of the welded portion 38 of the fuel tank 10 and the vicinity thereof, although the welded portion 38 of the fuel tank 10 is designed not to protrude upward or not to protrude upward largely from an outer surface of the fuel tank 10.

Although the preferred embodiment has been described, this is one of examples of the present invention.

For example, in the above embodiment, the weld joint is entirely made of a single resin alloy material, However, the weld joint may have a single layer construction or a multilayer construction made of other resin material than those in the above embodiment. And, in the above embodiment, the fuel tank is provided with the depressed portion defined by a portion around the welded portion and the welded portion has a shape rising from the depressed portion. However, according to the circumstances, the welded portion may be shaped so as to rise or protrude from an outer surface of the fuel tank 10 without forming such depressed portion, and reinforcing ribs may be provided so as to extend radially around the welded portion. And, the number of the reinforcing ribs or the shape of the reinforcing ribs may be varied. As such, the present invention may be constructed and embodied in various configurations and modes within the scope of the present invention.

What is claimed is:

1. A fuel tank assembly, comprising:
a resin fuel tank having an annular welded portion around an opening formed in the fuel tank; and
a resin weld joint including a tubular portion for connecting to a tube or a connector in piping, and an annular weld portion at a base end portion of the weld joint, the weld joint being mounted to the fuel tank by bonding the weld portion to the annular welded portion through application of heat-welding under pressure;
wherein the fuel tank is provided with reinforcing ribs arranged radially around the annular welded portion.

2. The fuel tank assembly as set forth in claim 1, wherein the fuel tank has a depressed portion that is depressed inwardly into the fuel tank around the annular welded portion throughout an entire circumference of the annular welded portion, the annular welded portion has a cylindrical shape rising and projecting from the depressed portion toward outside the fuel tank, and the reinforcing ribs extend radially across the depressed portion.

3. The fuel tank assembly as set forth in claim 2, wherein the annular welded portion has a welded surface that is at the same height as an outer surface of a portion of the fuel tank around the depressed portion.

4. A resin fuel tank to which a resin weld joint is mounted, the fuel tank, comprising:
a resin tank body;
an opening formed in the tank body; and
an annular welded portion of the tank body around the opening, the annular welded portion being adapted for bonding an annular weld portion of the weld joint thereto by heat-welding under pressure;
reinforcing ribs arranged radially in the tank body around the annular welded portion.

5. The resin fuel tank as set forth in claim 4, further comprising:
a depressed portion in the tank body around the annular welded portion, the depressed portion being depressed inwardly into the tank body throughout an entire circumference of the annular welded portion;
wherein the annular welded portion has a cylindrical shape rising and projecting from the depressed portion toward outside the tank body, and the reinforcing ribs extend radially across the depressed portion.

6. The resin fuel tank as set forth in claim 5, wherein the annular welded portion has a welded surface that is at the same height as an outer surface of a portion of the tank body around the depressed portion.

7. A fuel tank assembly, comprising:
a resin fuel tank having an annular weld mounting portion around an opening formed in the fuel tank; and
a resin weld joint including a connecting portion for piping, and an annular weld portion, the weld joint being mounted to the fuel tank by pressing and welding the weld portion to the weld mounting portion through application of heat-welding;
wherein the fuel tank has a plurality of depressed portions depressed inwardly into the fuel tank around the weld mounting portion, the depressed portions are arranged discontinuously in a circumferential direction along the weld mounting portion so as to form a partition wall between each adjacent pair of the depressed portions, the partition walls extend radially and each of the partition walls serves as a reinforcing rib.
